(19) United States
(12) Patent Application Publication
(10) Pub. No.: US 2010/0309980 A1
(43) Pub. Date: Dec. 9, 2010

(54) APPARATUS AND METHOD FOR PROCESSING IMAGE

(75) Inventors: Shingo SUZUKI, Akishima-shi (JP); Hirofumi Mori, Koganei-shi (JP); Masami Morimoto, Fuchu-shi (JP); Tatsunori Saito, Sagamihara-shi (JP)

Correspondence Address: HOLTZ, HOLTZ, GOODMAN & CHICK PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/477,335

(22) Filed: Jun. 3, 2009

(51) Int. Cl. H04N 7/26

(52) U.S. Cl. 375/240.16; 375/E07.123

(57) ABSTRACT

A motion detection unit detects a motion vector of each of blocks constituting interpolation frame F_{t-0.5} on the basis of two frames that are timely sequential. A motion vector smoothing unit removes an impulse noise-like motion vector, of the motion vectors detected by the motion detection unit. An edge group formation unit divides decoding frame Ft in rectangular block unit, as a reference frame, obtains an edge correlation between timely blocks and an edge correlation between spatial blocks, and groups blocks having high correlation. A motion vector correction unit subjects the smoothed motion vector to correction common to the grouped blocks, on the basis of the grouping result.

### BACKGROUND OF THE INVENTION

1. Field of the Invention

The present invention relates to an image processing apparatus capable of improving quality of a moving image.

2. Description of the Related Art

As a technique of increasing the number of display frames per unit time, frame interpolation is known. The frame interpolation increases the number of display frames per unit time by predicting and interpolating a frame which may be present between moving image frames which are provided. By the frame interpolation, inter-frame connection is smoothed, and a feeling of display blur disappears.

As such a frame interpolation method, the frame interpolation is performed by motion detection using edge information in Jpn. Pat. Appln. KOKAI Publication No. 2004-112229. This method has an advantage that noise in fine motion of the edge, gaps and overlapping after interpolation, or block distortion does riot occur. However, application to a processor mounted in a cellular telephone or the like is difficult due to its low processing power. In addition, a problem arises that interpolation processing becomes complicated since a block matching region and a block mismatching region between frames are detected and partially processed.

### BRIEF SUMMARY OF THE INVENTION

The present invention has been accomplished to solve the above-described problems. The object of the present invention is to provide an image processing apparatus capable of performing frame interpolation reducing the processing amount while maintaining the image quality.

To achieve the above object, the present invention comprises: a motion vector detection unit which detects a motion vector for each of blocks constituting a moving image frame obtained by decoding encoded data; an edge detection unit which detects an edge included in the block; a grouping unit which groups adjacent blocks on the basis of the edge detected by the edge detection unit; a correction unit which corrects the motion vector of each block, for each of groups formed by the grouping unit; a signal generation unit which generates an interpolation frame, on the basis of the motion vector corrected by the correction unit; and an outputting unit which selectively outputs the moving image frame and the interpolation frame.

In the present invention, adjacent blocks are grouped on the basis of the edge included in the blocks, and a motion vector of each block is corrected for each group to generate the interpolation frames.

Therefore, the present invention can provide an image processing apparatus and method capable of restricting occurrence of the noise in fine motion of the edge, gaps and overlapping after the interpolation, and the block distortion for each group based on the edge, irrespective of a low processing ability of the processor, and thereby performing the frame interpolation reducing the processing amount while maintaining the image quality.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a structure of a mobile radio terminal equipped with an image processing apparatus according to an embodiment of the present invention;

FIG. 2 is a block diagram showing a structure of the image processing apparatus shown in FIG. 1;

FIGS. 3A and 3B are illustration showing interpolation processing of a frame interpolating unit shown in FIG. 2;

FIG. 4 is a flowchart showing group formation processing of an edge group forming unit shown in FIG. 2;

FIG. 5 is a flowchart showing detection processing of edge time correlation shown in FIG. 4;

FIG. 6 is a flowchart showing detection processing of edge space correlation shown in FIG. 4; and

FIG. 7 is a flowchart showing correction processing of a motion vector correcting unit shown in FIG. 2.

### DETAILED DESCRIPTION OF THE INVENTION

Embodiments of the present invention will be explained below with reference to the accompanying drawings.

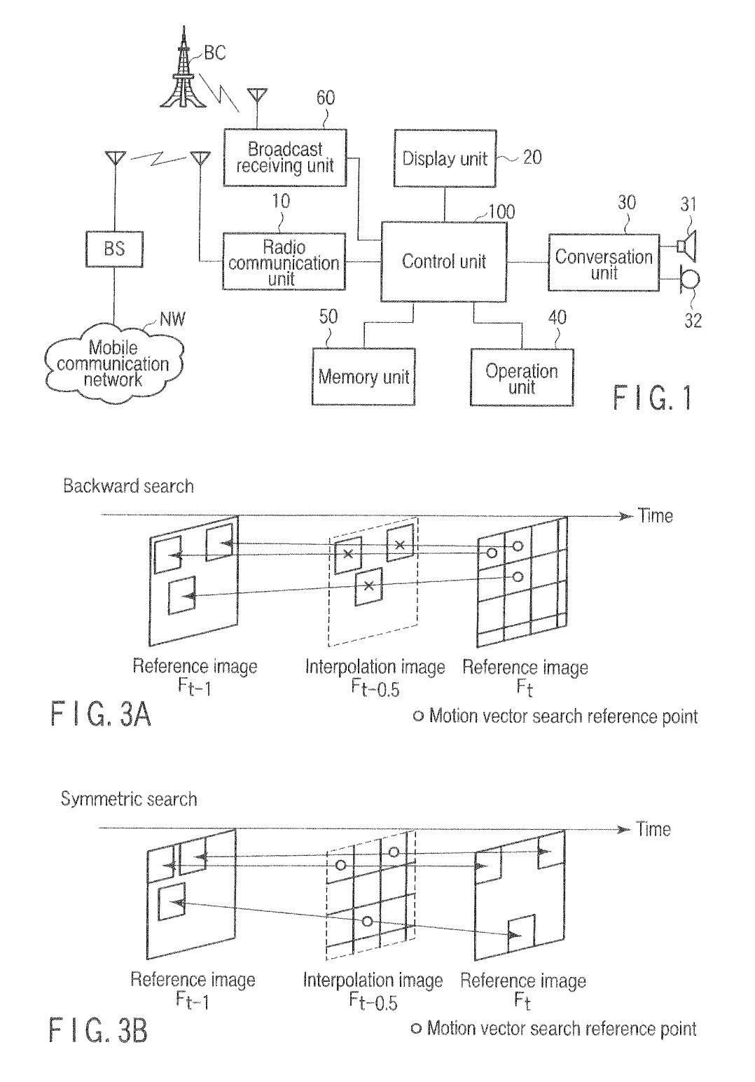

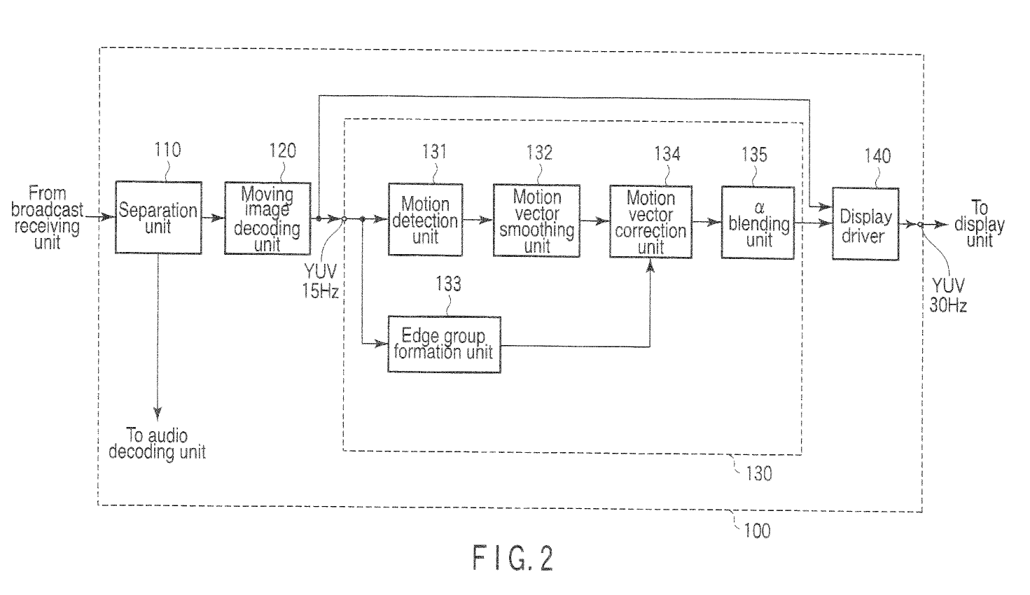

FIG. 1 is a block diagram showing a structure of a mobile radio terminal equipped with an image processing apparatus according to an embodiment of the present invention. The mobile radio terminal comprises as its main constituent elements, a control unit 100, a radio communication unit 10, a display unit 20, a conversation unit 30, an operation unit 40, a memory unit 50 and a broadcast receiving unit 60 and also comprises functions for performing communications via a base station apparatus BS and a mobile communication network NW and receiving a ground digital broadcast signal transmitted from a broadcast station BC as shown in FIG. 1.

The radio communication unit 10 performs radio communications with the base station with the base station apparatus BS accommodated in the mobile communication network NW under instructions of the control unit 100, to perform the transmission and reception of speech data, electronic mail data and the like and the reception of Web data, streaming data and the like.

The display unit 20 visually transmits information to the user by displaying images (still images and moving images), character information and the like under control of the control unit 100.

The conversation unit 30 comprises a speaker 31 and a microphone 32, and converts user's speech input via the microphone 32 into speech data and outputs the speech data to the control unit 100, and decodes speech data received from a conversation partner or the like and outputs the decoded data from the speaker 31.

The operation unit 40 comprises a plurality of key switches and the like, and accepts instructions from the user via the key switches and the like.

The memory unit 50 stores control programs and control data of the control unit 100, application software, address data in which names, telephone numbers and the like of communication partners are associated, transmitted and received electronic mail data, Web data downloaded by Web browsing, and downloaded content data, and temporarily stores streaming data and the like. Tie memory unit 50 comprises one or more memory means such as HDD, RAM, ROM, IC memory and the like.

The broadcast receiving unit 60 receives a one-segment signal, of ground digital broadcast signals transmitted from a broadcast station BC, and obtains broadcast data of an image signal encoded in a format of, for example, H.264 or the like (encoded stream).

The control unit 100 comprises a microprocessor, makes operations under control programs and control data stored in the memory unit 50 and entirely controls each of the units of the mobile radio terminal to implement speech communications and data communications. In addition, the control unit 100 makes operations under application software stored in the memory unit 50, and has a communication control function for transmission and reception of electronic mails, Web browsing, displaying a moving image on the display unit 20 on the basis of downloaded streaming data, and speech communications.

Further, the control unit 100 comprises a broadcast receiving function for decoding the broadcast data obtained by the broadcast receiving unit 60, subjecting a decoding result to image processing, and displaying the broadcast image on the display unit 20. The control unit 100 comprises a separation unit 110, a moving image decoding unit 120, a frame interpolation unit 130, and a display driver 140, to implement the broadcast receiving function. The control unit 100 also comprises an audio decoding unit which decodes audio data separated by the separation unit 110 though not shown.

The separation unit 110 separates the data received by the radio communication unit 10 or the broadcast receiving unit 60 to moving image data encoded in the format such as H. 264 or the like and audio data in the format such as AAC or the like, outputs the encoded moving image data to the moving image decoding unit 120 and outputs the encoded audio data to the audio decoding unit.

The moving image decoding unit 120 decodes the encoded data (Video Elementary Stream) of the moving image separated by the separation unit 110, and thereby obtains moving image data constituted by a plurality of moving image frames Fₜ. The frame rate of the moving image data obtained at this time is 15 Hz.

In addition, the moving image decoding unit 120 extracts quantization step QP and display timing PTS (Presentation Time Stamp) of each of macro-blocks constituting the moving image frames. The moving image data are output to the frame interpolation unit 130 and the display driver 140.

The frame interpolation unit 130 generates interpolation frame F_{t-0.5} which is to be present between the moving image frame Fₜ and moving image frame Fₜ₋₁ present prior to the moving image frame Fₜ by one frame. The frame interpolation unit 130 comprises a motion detection unit 131, a motion vector smoothing unit 132, an edge group formation unit 133, a motion vector correction unit 134, and an α blending unit 135.

The motion detection unit 131 comprises a memory which buffers at least two frames of the moving image data obtained by the moving image decoding unit 120, and performs the motion detection of the interpolation frame F_{t-0.5} for each rectangular block, i.e. detects a motion vector of each of blocks constituting the interpolation frame F_{t-0.5} on the basis of two moving image frames sequential in time.

More specifically, in a manner called Backward Search, for example, the moving image frame Ft serves as a reference frame is divided in the rectangular block, and compared with the buffered previous moving image frame Fₜ₋₁ in an order of raster scanning from the upper left block, and the motion detection of the interpolation frame F_{t-0.5} is performed for each rectangular block, as shown in FIG. 3A. An evaluation value utilized at the motion detection may be differential absolute sum or irregularity of the motion vector may be added to the differential absolute sum.

In addition, the interpolation frame F_{t-0.5} is divided into the rectangular block, and the motion detection is performed in the order of raster scanning from the upper left block, as shown in FIG. 3B. At this time, the motion detection is performed such that motions of (at least) two buffered moving image frames Fₜ, Fₜ₋₁ are symmetrical about the interpolation frame F_{t-0.5} serving as a base point.

The motion vector smoothing unit 132 performs smoothing processing for each of the rectangular blocks and removes an impulse noise-like motion vector, of the motion vectors detected by the motion detection unit 131. As a concrete example of the processing, the motion vector smoothing unit 132 recognizes the motion vector of the rectangular block to be subjected to the processing (hereinafter called block to be smoothed) and the motion vectors of the rectangular blocks adjacent to the block to be smoothed as candidate motion vector group W (MV₁-MVN), determines motion vector MVi (where i varies from 1 to N sequentially) serving as the base point, in the candidate motion vector group W, calculates distances from the MVi to the other candidate motion vectors MVj (MV1 to MVN), and calculates the sum of the distances (|MVi-MV1|+|MVi-MV2|+. . . +|MVi-MVN|). Then, the motion vector smoothing unit 132 obtains the motion vector by which the sum of the distances becomes minimum by varying the MVi (where i varies from 1 to N), and outputs the motion vector as a motion vector of the block to be smoothed (hereinafter called smoothed motion vector). In other words, the motion vector smoothing unit 132 obtains the smoothed motion vector in the following formula.

$$Smoothed motion vector = {arg min}_{MVi ∈ W} {\sum }_{j = 1}^{N} \vert MVi - MVj \vert$$

The adjacent blocks are the blocks which are adjacent in a time direction or the blocks which are adjacent in a space direction. The motion vector smoothing unit 132 may refer to the motion vectors in either of the blocks or the motion vectors in both the blocks.

The edge group formation unit 133 utilizes the moving image frame Ft as the reference frame and divides the reference frame in the rectangular block unit, performs edge detection in the order of raster scanning from the upper left block, obtains each of time edge correlation between blocks and spatial edge correlation between blocks, on the basis of the detection result and the edge detected from the previous decoding frame, and groups the blocks having high correlation. Such formation of the edge group does not need to be performed for all the frames, but the processing may be performed in terms of the only frames for which the formation of the edge group is judged necessary on the basis of the detection result of the motion detection unit 131.

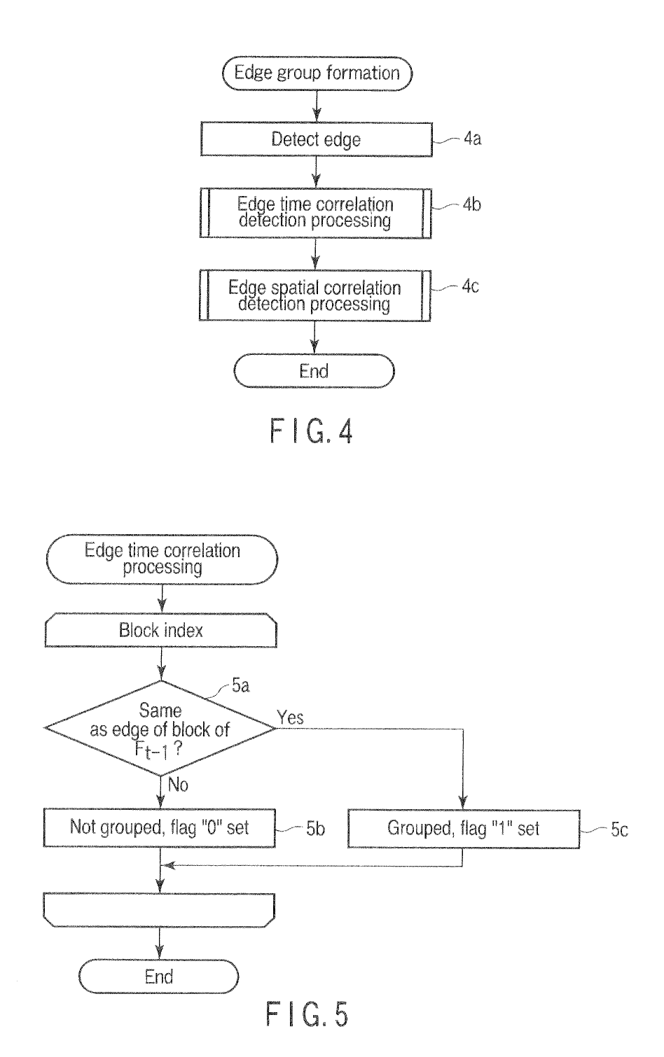

An example of processing for forming the edge group by the edge group formation unit 133 is described with reference to flowcharts shown in FIG. 4 to FIG. 6.

In step 4a, the edge group formation unit 133 divides the moving image frame Ft in the rectangular block unit, as the reference frame, and performs edge detection in the order of raster scanning from the upper left block. Then, the edge group formation unit 133 stores type information representing the direction of the detected edge, for each block, in the memory built in the edge group formation unit 133, and shifts to step 4b. As the type information of each block, the moving image frame Fₜ and the moving image frame Fₜ₋₁ arranged immediately before the moving image frame Ft by one frame, i.e. at least two frames sequential in time are stored.

In step 4b, the edge group formation unit 133 obtains the edge correlation between the timely blocks of two moving image frames, in the order of the raster scanning from the upper left block of the moving image frame Ft, and performs the processing for grouping the blocks having high correlation, on the basis of the detection result of step 4a and the edge detected from the previous moving image frame Ft-1. Then, the edge group formation unit 133 shifts to step 4c. FIG. 5 shows the details of the processing in step 4b, and the shown processing is performed for each block. The processing is described below with reference to FIG. 5. In the following descriptions, the block subjected to the processing is called a block to be processed.

In step 5a, the edge group formation unit 133 compares the type information of the edge detected in the block to be processed with the type information of the edge detected in a block of the previously processed moving image frame Ft-1 which corresponds to the block to be processed (hereinafter called previous time block), and discriminates whether or not the type information of the edges of both the blocks is the same. If the type information is the same, the edge group formation unit 133 shifts to step 5c. If the type information is not the same, the edge group formation unit 133 shifts to step 5b.

In step 5b, the edge group formation unit 133 sets flag “0” indicating that the block to be processed is not grouped with the previous time block, for the block to be processed, and ends the processing. If a block which is not subjected to the processing is present, the edge group formation unit 133 performs the processing again from step 5a by utilizing the block as the block to be processed.

In step 5c, the edge group formation unit 133 sets flag “1” indicating that the block to be processed is grouped with the previous time block, for the block to be processed, and ends the processing. If a block which is not subjected to the processing is present, the edge group formation unit 133 performs the processing again from step 5a by utilizing the block as the block to be processed.

Step 4c is described by referring to FIG. 4 again.

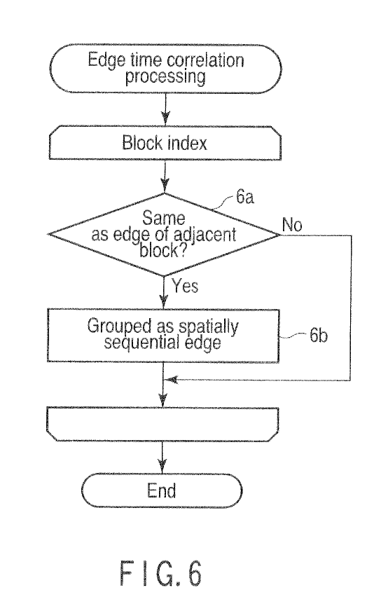

In step 4c, the edge group formation unit 133 motion detection unit 131 obtains the edge correlation between the blocks which are spatially adjacent to each other in the moving image frame Ft, in the order of raster scanning from the upper left block of the moving image frame Ft, performs the processing for grouping the blocks having high correlation, on the basis of the detection result of step 4a, and ends the processing. FIG. 6 shows the details of the processing in step 4c, and the processing shown in this figure is performed for each block. The processing is described below with reference to FIG. 6. In the following descriptions, the block subjected to the processing is called a block to be processed.

In step 6a, the edge group formation unit 133 compares the type information of the edge detected in the block to be processed with the type information of the edge in a block which is spatially adjacent to the block to be processed (hereinafter called adjacent block), and discriminates whether or not the type information of the edges in both the blocks is the same. If the type information is the same, the edge group formation unit 133 shifts to step 6b. If the type information is not the same, the edge group formation unit 133 ends the processing. If a block which is not subjected to the processing is present, the edge group formation unit 133 performs the processing again from step 6a by utilizing the block as the block to be processed.

In step 6b, the edge group formation unit 133 sets flag “1” indicating that the block to be processed is grouped with the adjacent block having the same type information of the edge, for the block to be processed, and ends the processing. If a block which is not subjected to the processing is present, the edge group formation unit 133 performs the processing again from step 6a by utilizing the block as the block to be processed.

The motion vector correction unit 134 subjects the smoothed motion vector to common correction for each grouped block, on the basis of the smoothed motion vector obtained by the motion vector smoothing unit 132 and the grouping result of the edge group formation unit 133. To exclude a fine edge from the correction, the correction is performed for the only group in which the number of grouped blocks is equal to or more than the preset number (threshold value THBlock).

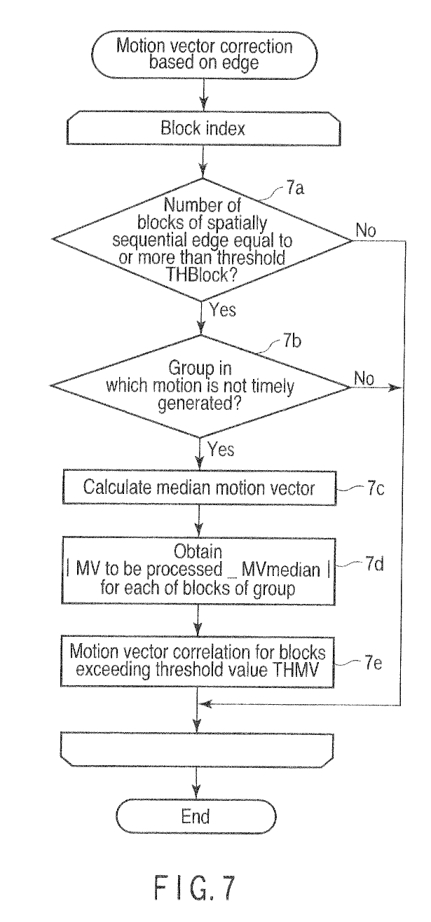

More specifically, the smoothed motion vector is corrected for each group, by the processing shown in FIG. 7. The correction is described below with reference to FIG. 7. In the following descriptions, a group subjected to the processing is called a group to be processed.

First, in step 7a, the motion vector correction unit 134 discriminates whether or not the group to be processed is the group in which the preset threshold value THBlock or more of blocks are sequential spatially, i.e. whether or not the group has the edge sequential to the preset threshold value THBlock or more of blocks, on the basis of the grouping result in step 4c.

If the group has the edge sequential to the threshold value THBlock or more of blocks, the motion vector correction unit 134 shifts to step 7b. If the group has the edge which is not sequential to the threshold value THBlock or more of blocks, the motion vector correction unit 134 ends the processing. If a group which is not subjected to the processing is present, the motion vector correction unit 134 performs the processing again from step 7a by utilizing the group as the group to he processed.

In step 7b, the motion vector correction unit 134 discriminates whether or not the group to be processed is the group in which the motion is not generated timely, i.e. the group to be processed is a group having high reliability of a median value obtained in subsequent step 7c, on the basis of the grouping result of step 4b.

If the group to be processed is the group in which the motion is not generated timely, the motion vector correction unit 134 shifts to step 7c. If the group to be processed is the group in which the motion is generated timely, the motion vector correction unit 134 ends the processing. If a block which is not subjected to the processing is present, the motion vector correction unit 134 performs the processing again from step 7a by utilizing the block as the block to be processed.

In step 7c, the motion vector correction unit 134 calculates motion vector MVmedian as the median value, to obtain the motion vector which is the noise element, on the basis of the smoothed motion vector of each of the blocks constituting the group to be processed. Then, the motion vector correction unit 134 shifts to step 7d.

In step 7d, the motion vector correction unit 134 obtains a difference between the smoothed motion vector and motion vector MVmedian obtained in step 7c, for each of the blocks constituting the group to be processed. Then, the motion vector correction unit 134 shifts to step 7e.

In step 7e, the motion vector correction unit 134 corrects the smoothed motion vector of the group in which the difference obtained in step 7d exceeds preset threshold value THMV to MVmedian, and ends the processing. If a block which is not subjected to the processing is present, the motion vector correction unit 134 performs the processing again from step 7a by utilizing the block as the block to be processed.

The α blending unit 135 calculates the reliability of the smoothed motion vector corrected from each continuity of the statistic quantity of the image, distortion and motion vector, on the basis of the smoothed motion vector corrected by the motion vector correction unit 134. The α blending unit 135 generates compensation blocks constituting the interpolation frame, on the basis of the corrected smoothed motion vector. Then, the α blending unit 135 synthesizes the blocks corresponding to each other, and generates interpolation frame F_{t-0.5}. The α blending unit 135 performs the synthesis at a synthesis ratio based on the reliability.

The display driver 140 stores the moving image frame Fₜ supplied from the moving image decoding unit 120 and interpolation frame F_{t-0.5} supplied from the frame interpolation unit 130 in the buffer memory, and outputs these frames alternately to the display unit 20. Each of the moving image frame Fₜ and the interpolation frame F_{t-0.5} has a frame rate of 15 Hz. However, moving image data having a frame rate of 30 Hz can be output by alternately outputting them by the display driver 140. Then, the display unit 20 displays the moving image data having a frame rate of 30 Hz.

In the image processing apparatus having the above-described structure, when the Interpolation frame F_{t-0.5} is generated by the frame interpolation unit 130, the timely correlation and the spatial correlation of the edge included in the blocks constituting the moving image frame are obtained, the blocks are grouped, the vector is corrected for each group, and the interpolation frame F_{t-0.5} is generated.

Therefore, noise in the fine motion of the edge, the gap and overlapping at the interpolation, and occurrence of the block distortion can be restricted for each group based on the edge, although the processing performance required for the processor is lower than that in the conventional manner. In other words, the frame interpolation reducing the processing amount can be performed while maintaining the image quality.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, as shown in FIG. 7, the motion vector is corrected, for the blocks having the number of spatially sequential blocks of the edge equal to or more than threshold value THBlock and having the edge in which the motion is not generated timely. Instead of this, for example, the motion vector may be corrected, for the blocks having the number of spatially sequential blocks of the edge equal to or more than threshold value THBlock or having the edge in which the motion is not generated timely.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image processing apparatus comprising:
a motion vector detection unit which detects a motion vector for each of blocks constituting a moving image frame obtained by decoding encoded data;
an edge detection unit which detects an edge included in the block;
a grouping unit which groups adjacent blocks on the basis of the edge detected by the edge detection unit;
a correction unit which corrects the motion vector of each block, for each of groups formed by the grouping unit;
a signal generation unit which generates an interpolation frame, on the basis of the motion vector corrected by the correction unit; and
an outputting unit which selectively outputs the moving image frame and the interpolation frame.

2. The apparatus of claim 1, wherein the signal generation unit comprises:
a reliability detection unit which detects reliability of the motion vector corrected by the correction unit;
a compensation block generation unit which generates a compensation block from the corrected motion vector; and
an interpolation frame generation unit which synthesizes the compensation block and the block of the moving image frame at a rate based on the reliability detected by the reliability detection unit, and generates the interpolation frame.

3. The apparatus of claim 1, wherein the correction unit corrects the motion vector of each of the blocks in the group having number of blocks therein equal to or more than a preset number, of the groups formed by the grouping unit.

4. The apparatus of claim 1, wherein the correction unit corrects the motion vector for each of the blocks in the group having no motion, of the groups formed by the grouping unit.

5. The apparatus of claim 1, wherein the correction unit obtains a value based on the motion vector of blocks in the groups, for each group, and corrects the motion vector smaller than a difference between the obtained value and a preset value.

6. The apparatus of claim 1, wherein the correction unit obtains a motion vector closest to an intermediate value, of the motion vectors of the blocks belonging to the groups, for each group, and corrects the motion vector smaller than a difference between the obtained value and a preset value.

7. An image processing method comprising:
detecting a motion vector for each of blocks constituting a moving image frame obtained by decoding encoded data;
detecting an edge included in the block;
grouping adjacent blocks on the basis of the edge detected in the edge detection;
correcting the motion vector of each block, for each of groups formed in the grouping step;
generating an interpolation frame, on the basis of the motion vector corrected in the correction; and
selectively outputting the moving image frame and the interpolation frame.

8. The method of claim 7, wherein the signal generation comprises:
detecting reliability of the motion vector corrected in the correction;
generating a compensation block from the corrected motion vector; and
synthesizing the compensation block and the block of the moving image frame at a rate based on the reliability detected in the reliability detection step, and generating the interpolation frame.

9. The method of claim 7, wherein the correction corrects the motion vector of each of the blocks in the group having number of blocks therein equal to or more than a preset number, of the groups formed in the grouping.

10. The method of claim 7, wherein the correction corrects the motion vector for each of the blocks in the group having no motion, of the groups formed in the grouping.

11. The method of claim 7, wherein the correction obtains a value based on the motion vector of blocks in the groups, for each group, and corrects the motion vector smaller than a difference between the obtained value and a preset value.

12. The method of claim 7, wherein the correction obtains a motion vector closest to an intermediate value, of the motion vectors of the blocks belonging to the groups, for each group, and corrects the motion vector smaller than a difference between the obtained value and a preset value.
